(19) United States
(12) Patent Application Publication
(10) Pub. No.: US 2010/0114568 A1
(43) Pub. Date: May 6, 2010

(54) APPARATUS FOR PROCESSING AN AUDIO SIGNAL AND METHOD THEREOF

(75) Inventors: Sung Yong Yoon, Seoul (KR); Hyun Kook Lee, Seoul (KR); Dong Soo Kim, Seoul (KR); Jae Hyun Lim, Seoul (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 12/605,905

(22) Filed: Oct. 26, 2009

Related U.S. Application Data
(60) Provisional application No. 61/108,031, filed on Oct. 24, 2008.

(51) Int. Cl. G10L 19/12

(52) U.S. Cl. 704/223

(57) ABSTRACT

An apparatus for processing an audio signal and method thereof are disclosed, by which extracting, by an audio processing apparatus, scheme type information indicating either time excitation scheme or frequency excitation scheme for each of a plurality of subframes included in current frame; when the time excitation scheme is applied to at least one subframe among the plurality of subframes according to the scheme type information, extracting mode information representing bit allocation of codebook index for the current frame; and, when the mode information is extracted, decoding the at least one subframe using the mode information according to the time excitation scheme.

### CROSS-REFERENCE TO RELATED APPLICATION

This application claims the benefit of U.S. Provisional Application No. 61/108,031 filed on Oct. 24, 2008, which is hereby incorporated by reference.

### BACKGROUND OF THE INVENTION

1. Field of the Invention

The present invention relates to an apparatus for processing an audio signal and method thereof. Although the present invention is suitable for a wide scope of applications, it is particularly suitable for encoding or decoding audio signals.

2. Discussion of the Related Art

Generally, an audio characteristic based coding scheme is applied to such an audio signal as a music signal and a speech characteristic based coding scheme is applied to a speech signal.

However, if one prescribed coding scheme is applied to a signal in which an audio characteristic and a speech characteristic are mixed with each other, audio coding efficiency is lowered or a sound quality is degraded.

### SUMMARY OF THE INVENTION

Accordingly, the present invention is directed to an apparatus for processing an audio signal and method thereof that substantially obviate one or more of the problems due to limitations and disadvantages of the related art.

An object of the present invention is to provide an apparatus for processing an audio signal and method thereof, by which a coding scheme of a different type can be applied per frame or subframe.

Another object of the present invention is to provide an apparatus for processing an audio signal and method thereof, by which information on a specific coding scheme can be encoded based on a relation between the specific coding scheme and information related to the specific coding scheme in applying coding schemes of different types.

Another object of the present invention is to provide an apparatus for processing an audio signal and method thereof, by which information related to a specific coding scheme can be efficiently obtained from a bitstream.

A further object of the present invention is to provide an apparatus for processing an audio signal and method thereof, by which information on a specific coding scheme can be encoded based on a characteristic of having an almost same value per frame in transmitting information related to the specific coding scheme.

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, a method for processing an audio signal, comprising: extracting, by an audio processing apparatus, scheme type information indicating either time excitation scheme or frequency excitation scheme for each of a plurality of subframes included in current frame; when the time excitation scheme is applied to at least one subframe among the plurality of subframes according to the scheme type information, extracting mode information representing bit allocation of codebook index for the current frame; and, when the mode information is extracted, decoding the at least one subframe using the mode information according to the time excitation scheme.

According to the present invention, further comprises: when the frequency excitation scheme is applied to all the plurality subframes according to the scheme type information, decoding the all the plurality subframes according to the frequency excitation scheme.

According to the present invention, the decoding the at least one subframe comprises: extracting the codebook index using the mode information; and, decoding the at least one subframe using the codebook index according to the time excitation scheme.

According to the present invention, when the time excitation scheme is applied to at least one subframe among the plurality of subframes according to the scheme type information, extracting flag information indicating whether the mode information corresponds to either difference value or absolute value; and, when the flag information indicates that the mode information corresponds to difference value, obtaining a mode value of the current frame using the mode information of the current frame and a mode value of a previous frame.

To further achieve these and other advantages and in accordance with the purpose of the present invention, an apparatus for processing an audio signal, comprising: a scheme type information obtaining part extracting scheme type information indicating either time excitation scheme or frequency excitation scheme for each of a plurality of subframes included in current frame; a mode information obtaining part, when the time excitation scheme is applied to at least one subframe among the plurality of subframes according to the scheme type information, extracting mode information representing bit allocation of codebook index for the current frame; and, a time excitation scheme unit, when the mode information is extracted, decoding the at least one subframe using the mode information according to the time excitation scheme is provided.

According to the present invention, the apparatus further comprises a frequency excitation scheme unit, when the frequency excitation scheme is applied to all the plurality subframes according to the scheme type information, decoding the all the plurality subframes according to the frequency excitation scheme.

According to the present invention, the apparatus further comprises a codebook information obtaining part extracting the codebook index using the mode information; and, wherein the time excitation scheme unit decodes the at least one subframe using the codebook index according to the time excitation scheme.

According to the present invention, the mode information obtaining part, when the time excitation scheme is applied to at least one subframe among the plurality of subframes according to the scheme type information, extracts flag information indicating whether the mode information corresponds to either difference value or absolute value, when the flag information indicates that the mode information corresponds to difference value, obtains a mode value of the current frame using the mode information of the current frame and a mode value of a previous frame.

To further achieve these and other advantages and in accordance with the purpose of the present invention, a method for processing an audio signal, comprising: obtaining scheme type information indicating either time excitation scheme or frequency excitation scheme for each of a plurality of subframes included in current frame; obtaining mode information representing bit allocation of codebook index for the current frame; and, when the time excitation scheme is applied to at least one subframe among the plurality of subframes according to the scheme type information, encoding the mode information by inserting the mode information into a bitstream is provided.

To further achieve these and other advantages and in accordance with the purpose of the present invention, an apparatus for processing an audio signal, comprising: a signal classifier obtaining scheme type information indicating either time excitation scheme or frequency excitation scheme for each of a plurality of subframes included in current frame; a time excitation scheme unit obtaining mode information representing bit allocation of codebook index for the current frame; and, a mode information encoding unit, when the time excitation scheme is applied to at least one subframe among the plurality of subframes according to the scheme type information, encoding the mode information by inserting the mode information into a bitstream is provided.

To further achieve these and other advantages and in accordance with the purpose of the present invention, a computer-readable medium having instructions stored thereon, which, when executed by a processor, causes the processor to perform operations, comprising: extracting, by an audio processing apparatus, scheme type information indicating either time excitation scheme or frequency excitation scheme for each of a plurality of subframes included in current frame; when the time excitation scheme is applied to at least one subframe among the plurality of subframes according to the scheme type information, extracting mode information representing bit allocation of codebook index for the current frame; when the time excitation scheme is applied to at least one subframe among the plurality of subframes according to the scheme type information, decoding the at least one subframe using the mode information according to the time excitation scheme is provided.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram of an encoder in an audio signal processing apparatus according to an embodiment of the present invention;

FIG. 2 is a diagram for describing a frame, subframes and scheme types;

FIG. 3 is a diagram for describing a scheme type for each subframe and scheme type information;

FIG. 4 is a diagram of a scheme type value for each subframe and a meaning thereof;

FIG. 5 is a table of a corresponding relation between a scheme type (mod [ ]) per subframe and scheme type information (lpd_mode) of a current frame;

FIG. 6 is a diagram for an example of a syntax for encoding scheme type information and mode information;

FIGS. 7A and 7B are diagrams for another example of a syntax for encoding scheme type information and mode information;

FIG. 8 is a diagram for an example of a syntax for encoding a codebook index;

FIG. 9 is a block diagram of a decoder in an audio signal processing apparatus according to an embodiment of the present invention;

FIG. 10 is a table for changing a scheme type (mod[ ]) according to scheme type information (lpd_mode);

FIG. 11 is a table for representing a value of scheme type information (lpd_mode) as a binary number;

FIG. 12 is a block diagram for an example of an audio signal encoding device to which an audio signal processing apparatus according to an embodiment of the present invention is applied;

FIG. 13 is a block diagram for a second example of an audio signal decoding device to which an audio signal processing apparatus according to an embodiment of the present invention is applied;

FIG. 14 is a schematic diagram of a product in which an audio signal processing apparatus according to an embodiment of the present invention is implemented; and

FIG. 15 is a diagram for relations of products provided with an audio signal processing apparatus according to an embodiment of the present invention.

### DETAILED DESCRIPTION OF THE INVENTION

Reference will now be made in detail to the preferred embodiments of the present invention, examples of which are illustrated in the accompanying drawings. First of all, terminologies or words used in this specification and claims are not construed as limited to the general or dictionary meanings and should be construed as the meanings and concepts matching the technical idea of the present invention based on the principle that an inventor is able to appropriately define the concepts of the terminologies to describe the inventor's invention in best way. The embodiment disclosed in this disclosure and configurations shown in the accompanying drawings are just one preferred embodiment and do not represent all technical idea of the present invention. Therefore, it is understood that the present invention covers the modifications and variations of this invention provided they come within the scope of the appended claims and their equivalents at the timing point of filing this application.

The following terminologies in the present invention can be construed based on the following criteria and other terminologies failing to be explained can be construed according to the following purposes. First of all, it is understood that the concept ‘coding’ in the present invention can be construed as either encoding or decoding in case. Secondly, ‘information’ in this disclosure is the terminology that generally includes values, parameters, coefficients, elements and the like and its meaning can be construed as different occasionally, by which the present invention is non-limited.

In this disclosure, in a broad sense, an audio signal is conceptionally discriminated from a video signal and designates all kinds of signals that can be auditorily identified. In a narrow sense, the audio signal means a signal having none or small quantity of speech characteristics. Audio signal of the present invention should be construed in a broad sense. And, the audio signal of the present invention can be understood as a narrow-sense audio signal in case of being used by being discriminated from a speech signal.

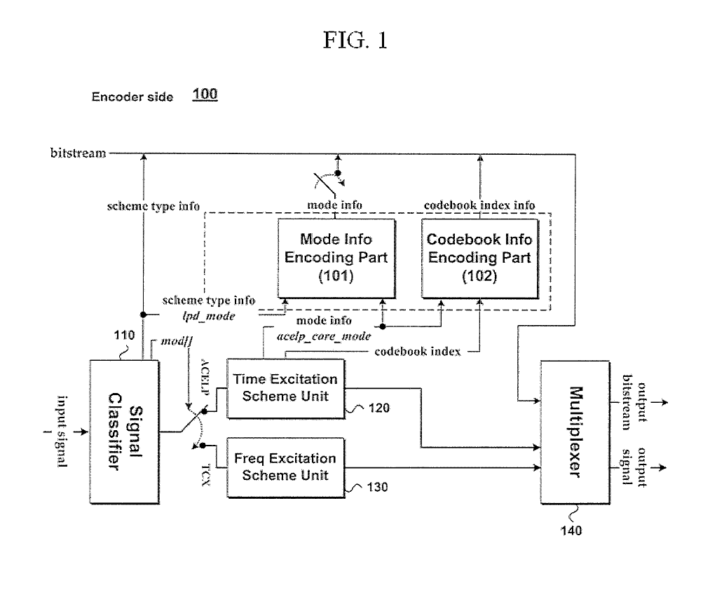

FIG. 1 is a block diagram for a diagram of an encoder in an audio signal processing apparatus according to one embodiment of the present invention.

Referring to FIG. 1, an encoder 100 of an audio signal processing apparatus can include a mode information encoding part 101 and a codebook information encoding part 102 and is able to further include a signal classifier 110, a time excitation scheme unit 120, a frequency excitation scheme unit 130 and a multiplexer 140.

An audio signal processing apparatus according to the present invention encodes mode information indicating a bit allocation of a codebook index, based on scheme type information indicating a scheme type of a subframe.

The signal classifier 110 determines whether an audio signal component of an input signal is stronger than a speech signal component and then determines whether to encode a current frame by an audio coding scheme or a speech coding scheme. In this case, the audio coding scheme may follow the AAC (advanced audio coding) standard or the HE-AAC (high efficiency advanced audio coding) standard, by which the present invention is non-limited. Meanwhile, once it is determined to encode a current frame by the speech coding scheme, it is determined whether to apply a time excitation scheme or a frequency excitation scheme will be applied to the current frame per subframe. In this case, the time or frequency excitation scheme corresponds to a scheme type.

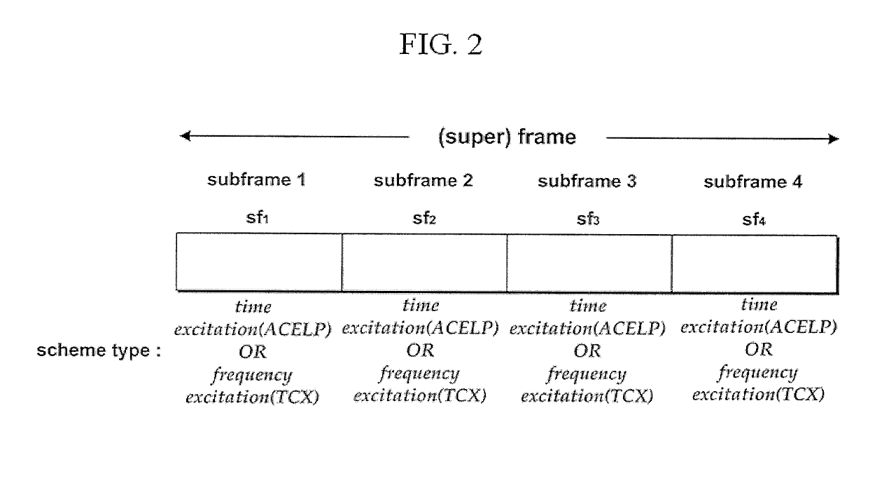

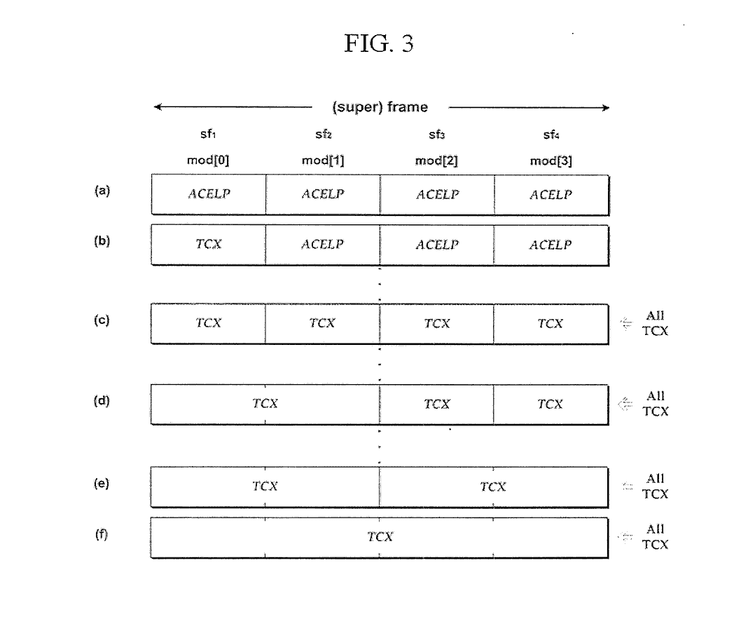

In the following description, a frame, a subframe and a scheme type are explained with reference to FIG. 2 and FIG. 3.

Referring to FIG. 2, a plurality of subframes (e.g. 4 subframes) sf₁ to sf₄ can exist within one frame. In this case, the frame can be named a super frame and the subframe can be named a frame. Namely, a relation between the frame and the subframe is non-limited by a specific terminology. This, each of the subframes belonging to the current frame can have a scheme type. The scheme type per subframe may include a time excitation scheme or a frequency excitation scheme. In this case, when a linear prediction coefficient and an excitation signal are obtained by performing a linear prediction coding (LPC) on an audio signal (or a speech signal), the time excitation scheme means a scheme of coding the excitation signal using several codebooks. The time excitation scheme can include such a scheme as CELP (code excitation linear prediction), ACELP (algebraic code excited linear prediction) and the like, by which the present invention is non-limited. On the contrary, the frequency excitation scheme is a scheme of performing a frequency transform on an excitation signal obtained by performing linear prediction as well. In this case, the frequency transform can be performed according to MDCT (modified discrete cosine transform), by which the present invention is non-limited. Thus, the information indicating a scheme type for each subframe is the scheme type information (lpd_mode) of the current frame.

Referring to FIG. 3, as mentioned in the foregoing description, a scheme type is determined for each subframe. In this case, a time excitation scheme (ACELP) or a frequency excitation scheme (TCX) is applicable as the scheme type. Scheme types of subframes Sf₁ to sf₄ shall be named first to fourth scheme types mod[0] to mod[3], respectively.

Referring to (a) of FIG. 3, it can be observed that the time excitation scheme (ACELP) is applied to all four subframes. In particular, each of the first to fourth scheme types mod[0] to mod[3] is ACELP. Meanwhile, referring to (b) of FIG. 3, the first scheme type mod[0] corresponds to TCX and the second scheme type mod[1] to mod[3] corresponds to ACELP.

Referring to (c) to (f) of FIG. 3, it can be observed that total four cases, each of which is a case that all subframes belonging to a current frame correspond to TCX, are shown. Referring to (c) of FIG. 3, it can be observed that each of first to fourth subframes sf₁ to sf₄ corresponds to TCX. Namely, all first to fourth coding schemes mod[0] to mod[3] are TCX.

Referring to (d) to (f) of FIG. 3, in case of TCX, TCX is applicable to one subframe only. And, it can be observed that TCX is also applicable to two consecutive subframes (or a half of a current frame) or four consecutive subframes (or an entire current frame). In (d) of FIG. 3, a first coding scheme mod[0] and a second coding scheme mod[1] are TCS for two consecutive subframes. A third coding scheme mod[2] is TCX for one subframe sf₃. And, a fourth coding scheme mod[3] is TCX for one subframe sf₄. In (e) of FIG. 3, shown is a case that TCX for two consecutive subframes is applied twice. In (f) of FIG. 3, shown is a case that TCX for four consecutive subframes is applied to an entire frame once. Thus, referring to (d) to (f) of FIG. 3, ACELP is not applied to all subframes belonging to a current frame but TCX is applied thereto only.

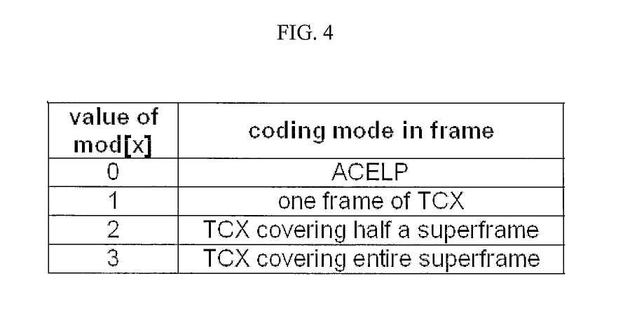

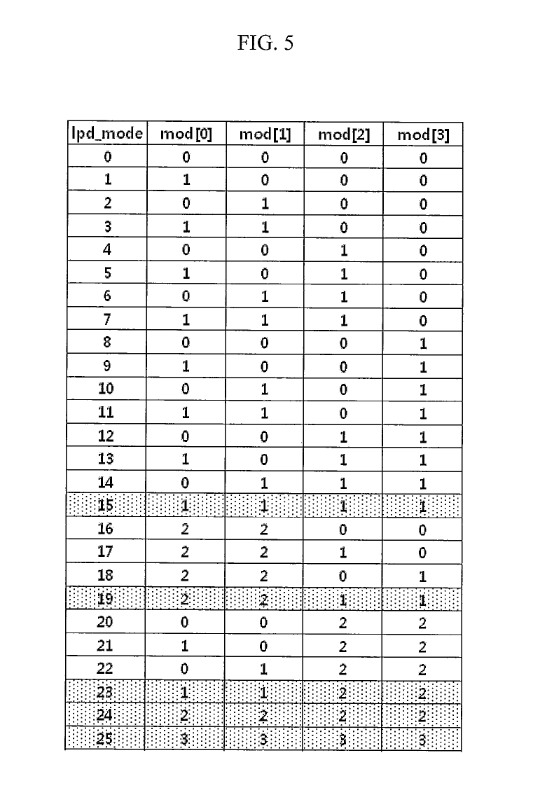

FIG. 4 shows a scheme type value for each subframe and a meaning thereof, and FIG. 5 is a table of a corresponding relation between a scheme type (mod[ ]) per subframe and scheme type information (lpd_mode) of a current frame.

Referring to FIG. 4, if a per-subframe coding scheme mod[ ] is ACELP, it can be represented as 0. If a per-subframe coding scheme mod[ ] is TCX, it can be represented as 1. If TCX covers half a frame, it can be represented as 2. If TCX covers an entire frame, it can be represented as 3. Thus, scheme type information of a current frame can be determined according to a scheme type mod[ ] for each subframe, of which example is shown in FIG. 5. Referring to FIG. 5, according to a combination of first to fourth scheme types mod[0] to mod[3], a value of scheme type information lpd_mode can be determined. Fir instance, if first to fourth scheme types mod[0] to mod[3] are all zero, a value of scheme type information lpd_mode of a current frame can become 0 (this corresponds to (a) of FIG. 3). Meanwhile, if a first scheme type mod[0] is 1 only and the rest of scheme types are zero, scheme type information of a current frame can become 1. In case that there are total 26 kinds of cases corresponding to combinations of first to fourth scheme types, as shown in FIG. 5, scheme type information of a current frame can be determined as 0 to 25. In this case, if TCX is used for an entire frame only, it corresponds to total 5 kinds of cases indicating that values of the scheme type information lpd_mode are 15, 19, 23, 24 and 25, respectively, as shown in FIG. 5. Thus, scheme types mod[ ] can be determined for subframes, respectively. According to a combination of the scheme types, scheme type information lpd_mode of a current frame can be determined.

Referring now to FIG. 1, the signal classifier 110 determines a scheme type for each subframe by analyzing a characteristic of the input signal. Based on the determined scheme type, the signal classifier 110 determines scheme type information lpd_mode of a current frame and then delivers the determined scheme type information lpd_mode to the mode information encoding part 101. According to the per-subframe scheme type mod[ ], the signal classifier 110 delivers the inputted signal to the time excitation scheme unit 120 or the frequency excitation scheme unit 130.

Meanwhile, if a current subframe corresponds to a time excitation scheme (ACELP) (e.g., if a subframe scheme type mod[ ] is 0), the time excitation scheme unit 120 performs encoding of a subframe according to the aforesaid time excitation scheme. In particular, as a result of performing linear prediction, a linear prediction coefficient and an excitation signal are obtained. The excitation signal is coded using a codebook index. The time excitation scheme unit 120 obtains the codebook index and mode information and then delivers them to the mode information encoding part 101. In this case, the mode information acelp_core_mode is the information indicating a bit allocation of a codebook index. For instance, in case of a first mode, a codebook index may include 20 bits. In case of a second mode, a codebook index may include 28 bits. Namely, since this mode information is the information on the codebook index, it is required only if a subframe corresponds to a time excitation scheme ACELP only. This mode information is not necessary if a subframe corresponds to a frequency excitation scheme.

Meanwhile, if a current frame corresponds to a frequency excitation scheme (TCX) (e.g., if a subframe scheme type mod[ ] is 1 to 3), the frequency excitation scheme unit 130 encodes a signal for a corresponding subframe (or at least two consecutive subframes, at least four consecutive subframes) according to the frequency excitation scheme (TCX). In particular, as mentioned in the foregoing description, the frequency excitation scheme unit 130 obtains spectral data in a manner of performing such a frequency transform as MDCT on an excitation signal obtained by performing linear prediction on an input signal.

The mode information encoding part 101 encodes mode information (acelp_core_mode) of a current frame based on the scheme type information lpd_mode of the current frame. In particular, in case that a time excitation scheme (ACELP) is applied to at least one of subframes belonging to a current frame, the mode information encoding part 101 encodes mode information of the current frame and then enables the encoded mode information to be included in a bitstream. Otherwise, if the time excitation scheme (ACELP) is not applied to all subframes belonging to a current frame (i.e., if a frequency excitation scheme (TCX) is applied to all subframes), the mode information encoding part 101 does not have the mode information of the current frame not included in the bitstream.

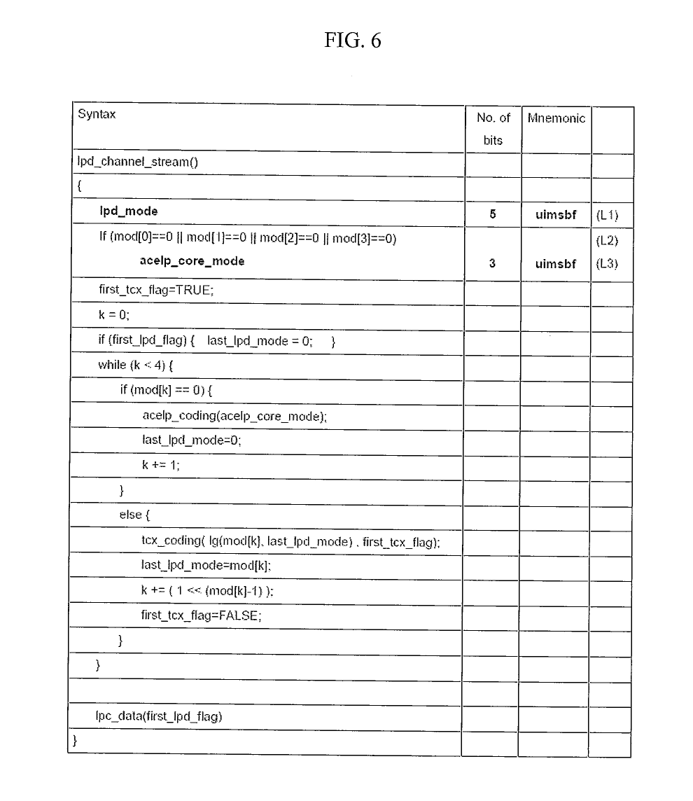

FIG. 6 shows an example of a syntax for encoding scheme type information and mode information. Referring to a row L2 and a row L3 shown in FIG. 6, if any one per-subframe scheme type mod[ ] is set to 0 [If ((mod[0]==0 mod[1]==0∥mod[2]==0∥mod[3]==0)], i.e., only if at least one subframe corresponding to ACELP exists, it can be observed that 3-bit mode information acelp_core_mode is included in a bitstream.

Meanwhile, the mode information needs about 3 bits occasionally. Instead of encoding a value corresponding to the mode information as it is, it is able to encode a result from performing Huffman coding on its difference vale. This can be more efficient in case that a difference between a value of a mode information of a previous frame and a value of mode information of a current frame is small. This, if it is possible to send a difference value instead of an absolute value per frame, a flag information indicating whether the mode information is the difference value or the absolute value can be further included.

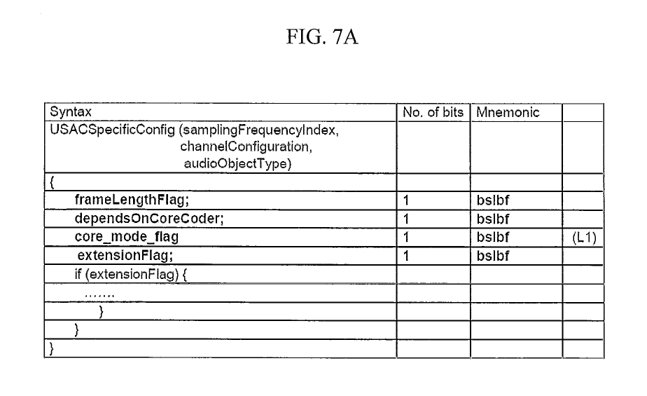

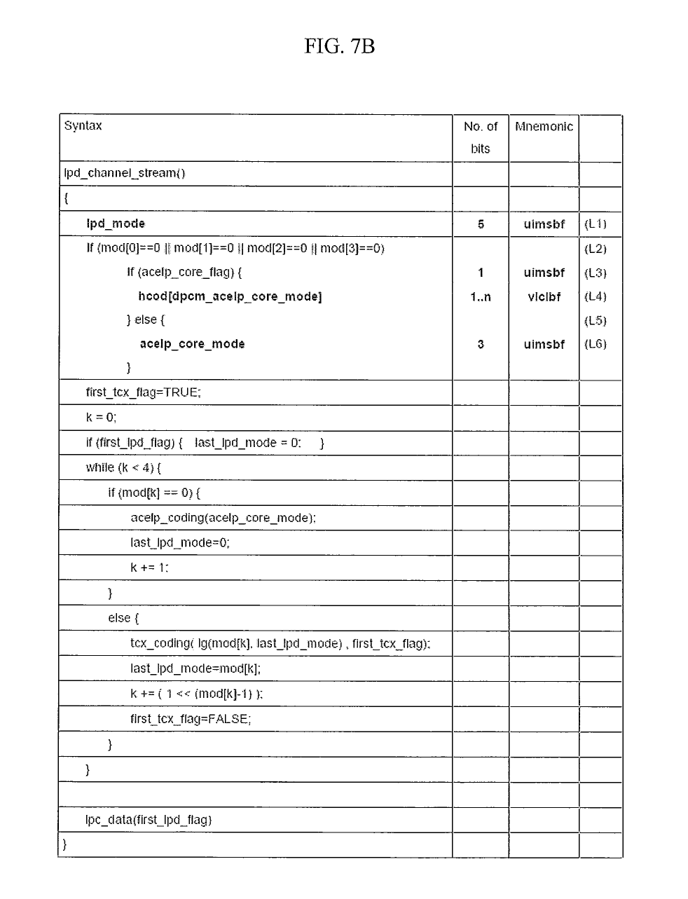

FIGS. 7A and 7B are diagrams for another example of a syntax for encoding scheme type information and mode information. Referring to a row L1 shown in FIG. 7A, it can be observed that a flag information acelp_core_flag indicating whether the mode information is the difference value or the absolute value can be further included. The flag information may be included in a header (USACSpecificConfig( )) in order to reduce bitrate. Referring to a row L1 shown in FIG. 7B, like the first example shown in FIG. 6, a scheme type information lpd_mode of a current frame exists. Referring to a row L2 shown in FIG. 7B, like the first example shown in FIG. 6, only if at least one subframe corresponding to ACELP exists, information related to the mode information is included in a bitstream. In particular, when the flag information extracted from the header (shown in FIG. 7A) indicates that the mode information is a difference value, it is observed that a difference value is extracted as shown in a row L3 and a row L4 of FIG. 7B. Moreover, in this case, it may be more efficient for the difference value of the mode information to be encoded by a variable length coding scheme such as Huffman coding rather than encoded with stationary bits. Hence, referring to a row L4 shown in FIG. 7B, it can be observed that the difference value is encoded with variable bits (1 . . . n, vlclbf) instead of being encoded with stationary bits. In other hands, when the flag information indicates that the mode information is a absolute value rather than a difference value, it is observed that a absolute value is extracted as shown in a row L5 and a row L6 of FIG. 7B. The absolute value of the mode information may be encoded by fixed length coding scheme rather than variable length coding scheme.

Furthermore, when mode information is the difference value, processing is performed as follows:

acelp_core_modeprev=0

acelp_core_mode=acelp_core_mode_prev+dpcm_acelp_core_mode

acelp_core_mode_prev=acelp_core_mode [Formula 1]

First of all, mode information of a previous frame is set to be zero as initial value. Secondly, the transferred difference value of current frame is added to the mode information of the previous frame. Therefore, mode information of current frame is reconstructed. Thirdly, the reconstructed mode information of current frame is set to be mode information of previous frame in order to obtaining mode information for next frame. For next frame, the second step and the third step may be repeatedly performed.

Referring now to FIG. 1, as mentioned in the foregoing description, the mode information encoding part 101 encodes the mode information based on the scheme type information lpd_mode of the current frame instead of encoding the mode information acelp_core_mode unconditionally.

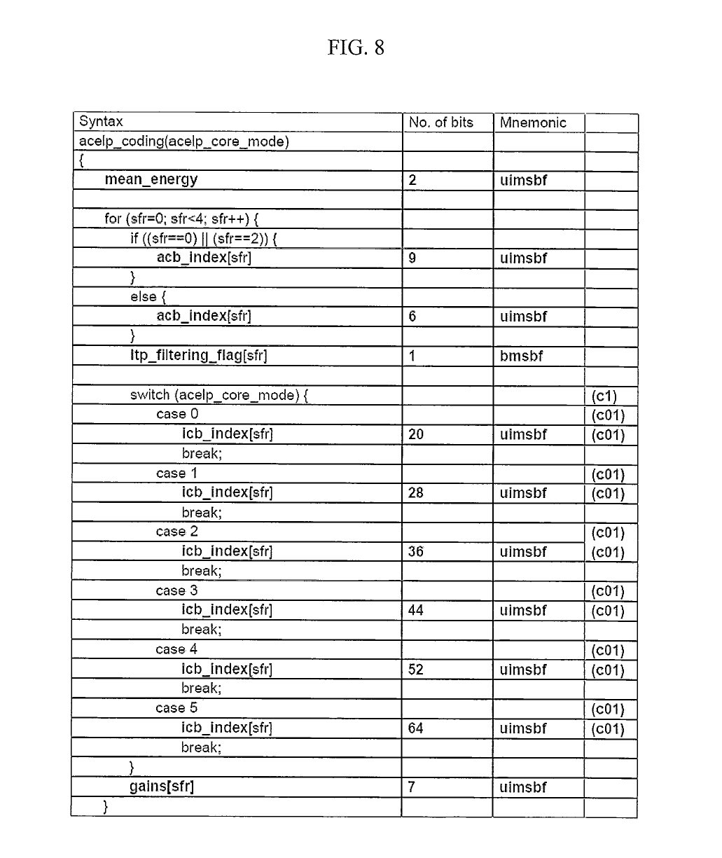

The codebook information encoding part 102 encodes a codebook index based on the mode information acelp_core_mode determined by the time excitation scheme unit 120. In particular, the codebook information encoding part 102 encodes the codebook index according to the number of bits corresponding to the mode information. FIG. 8 shows an example of a syntax for encoding a codebook index. Referring to a row L1 shown in FIG. 8, it can be observed that a codebook index is extracted according to mode information acelp_core_mode. Referring to rows L01 to L51, it can be observed that total 6 kinds of modes case 0 to case 5 exist. And, it can be also observed that a per-subframe codebook index icb_idex[sfr] is included for each of the cases. The bit This codebook index varies in the bit number (e.g., 20, 28, 36, etc.) according to each mode (i.e., each case).

Referring now to FIG. 1, the multiplexer 140 generates at least one bitstream by multiplexing the generated informations and signals together. In this case, the informations include the mode information encoded by the mode information encoding part 101 and the codebook index information encoded by the codebook information encoding part 102. and, the signals include the signals encoded by the time excitation scheme unit 120 and the frequency excitation scheme unit 130.

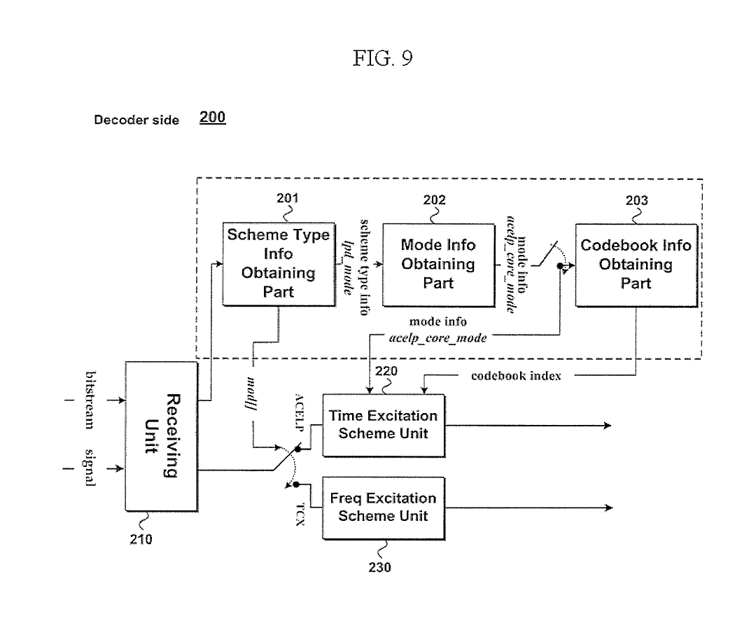

FIG. 9 is a block diagram of a decoder in an audio signal processing apparatus according to an embodiment of the present invention.

Referring to FIG. 9, an audio signal processing apparatus 200 includes a scheme type information obtaining part 201, a mode information obtaining part 202 and a codebook information obtaining part 203 and is able to further include a receiving unit 210, a time excitation scheme unit 220 and a frequency excitation scheme unit 230.

The receiving unit 210 receives a bitstream corresponding to information and an audio signal. Of course, it is able to configure the bitstream and the audio signal into one bitstream. Subsequently, the receiving unit 210 delivers the bitstream corresponding to the information to the scheme type information obtaining unit 201 and also delivers the audio signal to the time excitation scheme unit 220 or the frequency excitation scheme unit 230 for each subframe.

The scheme type information obtaining unit 201 extracts the scheme type information lpd_mode from the bitstream corresponding to the information. For instance, the scheme type information obtaining part 201 is able to extract the scheme type information lpd_mode based on the syntaxes shown in FIG. 6 and FIG. 7B. The extracted scheme type information lpd_mode is then delivered to the mode information obtaining part 202.

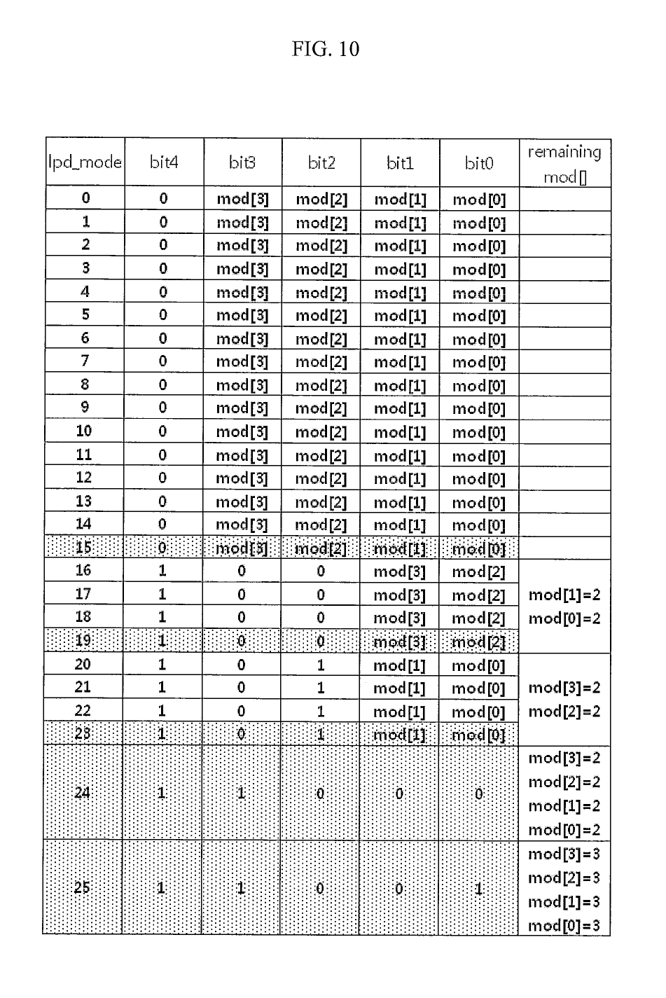

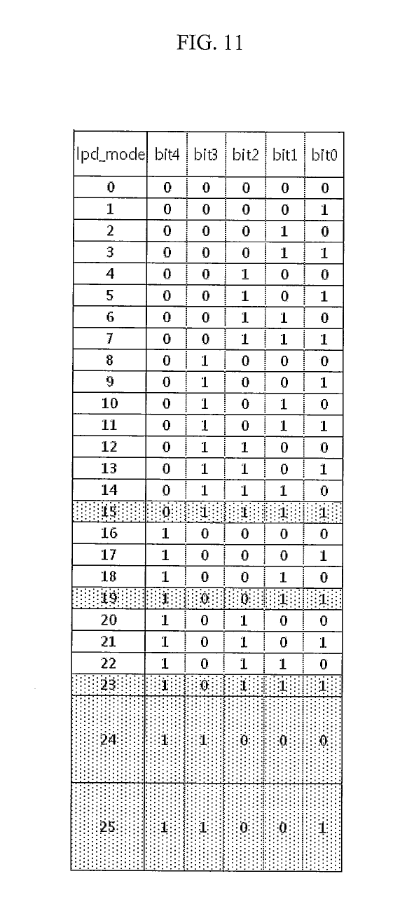

Meanwhile, the scheme type information obtaining part 201 determines a per-subframe scheme type mod[ ] based on the extracted scheme type information lpd_mode. In doing so, it is able to use a table for changing a scheme type mode[ ] according to scheme type information lpd_mode, of which example is shown in FIG. 10. Referring to FIG. 10, it is able to know a per-subframe scheme type mod[ ] according to a value of scheme type information lpd_mode of a current frame. In this case, bit 4 to bit 0 indicate bits of digits in values 0 to 25 of the scheme type information lpd_mode are represented as binary numbers, respectively. A bit of a first digit is bit 0 and a bit of a fifth digit is bit 4. To help the understanding, a table, in which a value of scheme type information lpd_mode is represented as a binary number, shown in FIG. 11 is referred to. Referring to FIG. 11, if lpd_mode is 15, it is represented as a binary number of ‘011110. The bit 4 is set to 0 and the bits 3 to 0 are set to 1, respectively.

Referring now to FIG. 10, if lpd_mode is 0, bit 4 is ignored. And, it can be observed that bit 3 (a scheme type of a fourth subframe) to bit 0 (a scheme type of a first subframe) correspond to mode[3] to mod[0], respectively. If lpd mode is 23, bit 1 and bit 0 correspond to mod[1] and mode[0], respectively. And, mode[3] and mod[2] are determined as 2. Thus, the corresponding relation shown in FIG. 10 is substantially equal to the former corresponding relation shown in FIG. 5.

Referring now to FIG. 9, as mentioned in the foregoing description, the scheme type information obtaining part 201 extracts the scheme type information lpd_mode from the bitstream and also determines a per-subframe scheme type mode[ ] based on the extracted scheme type information lpd_mode. The current per-subframe scheme type mod[ ] (and the scheme type information lpd_mode of the frame) is delivered to the mode information obtaining part 202. and, the per-subframe scheme type mod[ ] determines whether the received audio signal will be delivered to the time excitation scheme unit 220 or the frequency excitation scheme unit 230.

The mode information obtaining part 202 extracts the mode information according to the scheme type information lpd_mode of the current frame (or the per-subframe scheme type mod[ ]), In particular, as a result of the determination performed based on the scheme type of the current frame or the per-subframe scheme type, if a time excitation scheme (ACELP) is applied to at least one of a plurality of the subframes belonging to the current frame, the mode information obtaining part 202 extracts the mode information of the current frame. In this case, as mentioned in the foregoing description, the mode information is the information indicating the bit number allocation of the codebook index. On the contrary, if a frequency excitation scheme (TCX) is applied to all of a plurality of the subframes belonging to the current frame, the mode information is not necessary. Therefore, the extraction of the mode information is skipped. For instance, it is able to extract the mode information according to the rules shown in the rows L2 and L3 shown in FIG. 6. This mode information is delivered to the codebook information obtaining part 203.

Meanwhile, the flag information indicating whether the mode information is an absolute value or a difference value, as shown in FIG. 7A, can be occasionally included in the bitstream. In this case, the flag information is extracted. If the flag information indicates that the mode information is the absolute value (e.g., if acelp_core_flag is set to 0), the mode information is obtained as a mode value as it is. Otherwise, if the flag information indicates that the mode information is the difference value (e.g., if acelp_core_flag is set to 1), a current mode value is obtained by adding the formerly extracted mode information of the current frame and a mode value of a previous frame together. For instance, if the mode information of the current frame is 0 and the mode value of the previous frame is 3, the mode value of the current fame is 3 resulting from adding 3 and 0 together.

Thus, the mode information obtaining part 202 obtains the current mode information acelp_core_mode from the base station based on the scheme type information (or the per-subframe scheme type) of the current frame. When the mode information is obtained, the mode information is transferred to the codebook information obtaining part 204 and the time excitation scheme unit 220.

The codebook information obtaining part 203 extracts the codebook index from the bitstream using the mode information acelp_core_mode when the mode information is transferred from the mode information obtaining unit 202. In particular, the bit number allocation of the codebook index differs according to a mode. Information is read as a codebook index amounting to the bit number according to a corresponding case. For instance, as mentioned in the foregoing description with reference to FIG. 8, codebook index information (icb_index[sfr]) of the bit number differing for each of total 6 kinds of modes. The obtained codebook index is delivered to the time excitation scheme unit 220.

If the scheme type applied to the subframe is the time excitation scheme (ACELP), the time excitation scheme unit 220 decodes the subframe using the codebook index according to the time excitation scheme. The time excitation scheme is explained in detail in the former description and its details are omitted from the following description.

If the scheme type applied to the subframe is the frequency excitation scheme (TCX), the frequency excitation scheme unit 230 decodes the subframe(s) according to the frequency excitation scheme.

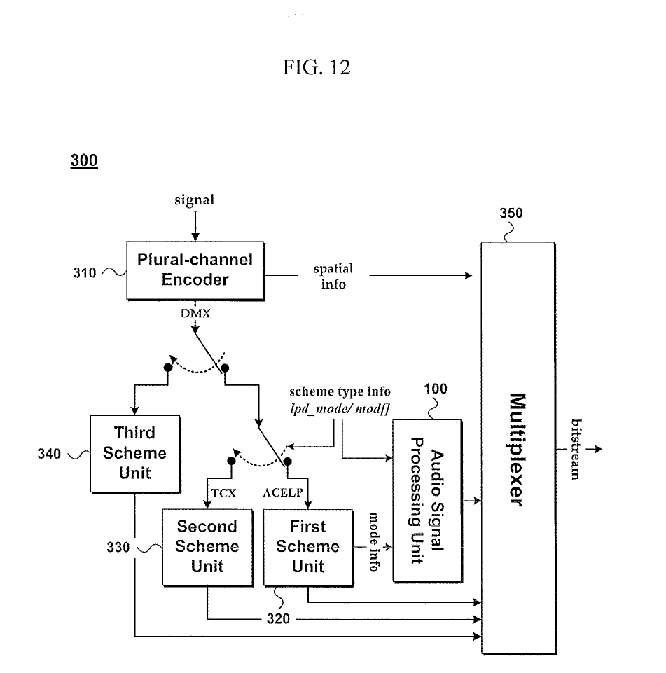

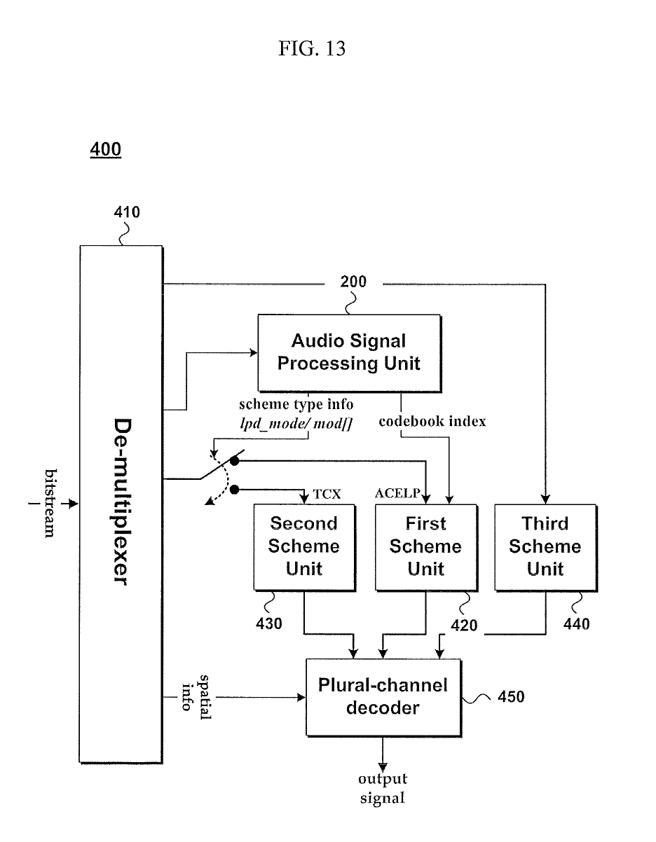

FIG. 12 shows an example of an audio signal encoding device to which an audio signal processing apparatus according to an embodiment of the present invention is applied and FIG. 13 shows a second example of an audio signal decoding device to which an audio signal processing apparatus according to an embodiment of the present invention is applied.

An audio signal processing apparatus 100 shown in FIG. 12 includes the mode information encoding part 101 and the codebook information encoding part 102, which are described with reference to FIG. 1. And, an audio signal processing apparatus 200 shown in FIG. 13 includes the scheme type information obtaining part 201, the mode information obtaining part 202 and the codebook information obtaining part 203, which are described with reference to FIG. 9.

Referring to FIG. 12, an audio signal encoding device 300 includes a plural channel encoder 310, an audio signal processing apparatus 100, a time excitation scheme unit 320, a frequency excitation scheme unit 330, a third scheme unit 340 and a multiplexer 350 and is able to further include a band extension encoding unit (not shown in the drawing).

The plural channel encoder 310 receives an input of a plural channel signal (a signal having at least two channels) (hereinafter named a multi-channel signal) and then generates a mono or stereo downmix signal by downmixing the multi-channel signal. and, the plural channel encoder 310 generates spatial information for upmixing the downmix signal into the multi-channel signal. In this case, the spatial information can include channel level difference information, inter-channel correlation information, channel prediction coefficient, downmix gain information and the like. If the audio signal encoding device 300 receives a mono signal, it is understood that the mono signal can bypass the plural channel encoder 310 without being downmixed.

The band extension encoder (not shown in the drawing) is able to generate spectral data corresponding to a low frequency band and band extension information for high frequency band extension. In particular, spectral data of a partial band (e.g., a high frequency band) of the downmix signal is excluded. And, the band extension information for reconstructing the excluded data can be generated.

The audio signal processing unit 100 can include the mode information encoding part 101 and the codebook information encoding part 102, which are explained with reference to FIG. 1. In particular, according to the scheme type information lpd_mode of a current frame (or scheme types mod[ ] for subframes), the information indicating the bit allocation of the codebook index is encoded.

In this case, the scheme type information lpd_mode of a current frame (or scheme types mod[ ] for subframes) may include the information generated by signal classifier (not shown in the drawing). And, the signal classifier may include the element performing the same function of the former element described with reference to FIG. 1.

The time excitation scheme unit 320 is the element for encoding a frame (or a subframe) according to a time excitation scheme and is able to perform the same function of the element having the same name formerly described with reference to FIG. 1. The frequency excitation scheme unit 323 is the element for encoding a frame (or a subframe) according to a frequency excitation scheme and is able to perform the same function of the element having the same name formerly described with reference to FIG. 1.

If a specific frame or segment of the downmix signal has a large audio characteristic, the third scheme unit 340 encodes the downmix signal according to an audio coding scheme. In this case, the audio coding scheme may follow the AAC (advanced audio coding) standard or HE-AAC (high efficiency advanced audio coding) standard, by which the present invention is non-limited. Meanwhile, the third scheme unit 340 can include a modified discrete cosine transform (MDCT) encoder.

And, the multiplexer 350 generates at least one bitstream by multiplexing the signals respectively encoded by the first to third scheme units 320 to 340 and the information encoded by the audio signal processing unit 100.

Referring to FIG. 13, an audio signal decoding device 400 includes a demultiplexer 410, an audio signal processing apparatus 200, a time excitation scheme unit 420, a frequency excitation scheme unit 430, a third scheme unit 440 and a plural channel decoder 450.

The demultiplexer 410 separates an audio signal bitstream into audio information and audio signal data. In this case, the demultiplexer 410 is able to extract spatial information and band extension information from the audio information. The demultiplexer 510 then delivers the audio information to the audio signal processing unit 200.

If a current frame is decoded by an audio coding scheme, the demultiplexer 410 delivers the corresponding audio signal data to the third scheme unit 440. Alternatively, the audio signal data can be delivered to the time excitation scheme unit 420 or the frequency excitation scheme unit 430 according to coding scheme information lpd_mode of a current frame or a per-subframe coding scheme mod[ ].

As mentioned in the foregoing description, the audio signal processing unit 200 can include the scheme type information obtaining part 201, the mode information obtaining part 202 and the codebook information obtaining part 203, which are described with reference to FIG. 9. The audio signal processing unit 200 obtains the coding scheme information lpd_mode of the current frame from the audio information, obtains mode information acelp_code_mode using the obtained coding scheme information, and then delivers a codebook index according to the mode information to the time excitation scheme unit 420.

The time excitation scheme unit 420 generates an excitation signal using the codebook index according to a time excitation scheme (ACELP) and then reconstructs a signal by performing linear prediction coding (LPC) based on the excitation signal and a linear prediction coefficient. The description of the time excitation scheme (ACELP) is omitted from the following description as well. The frequency excitation scheme unit 430 generates an excitation signal by frequency transform according to a frequency excitation scheme (TCX) and then reconstructs a signal by performing linear prediction decoding based on the excitation signal and a linear prediction coefficient.

If spectral data corresponding to a downmix signal has a large audio characteristic, the third scheme unit 440 decodes the spectral data according to an audio coding scheme. In this case, as mentioned in the foregoing description, the audio coding scheme can follow the AAC standard or the HE-AAC standard. Meanwhile, the audio signal decoder 430 can include a dequantizing unit (not shown in the drawing) and an inverse transform unit (not shown in the drawing).

The band extension decoding unit (not shown in the drawing) reconstructs a signal of a high frequency band based on the band extension information by performing a band extension decoding scheme on the output signals from the first to third scheme units 420 to 440.

And, the plural channel decoder 450 generates an output channel signal of a multi-channel signal (stereo signal included0 using spatial information of the decoded audio signal is a downmix.

The audio signal processing apparatus according to the present invention is available for various products to use. Theses products can be mainly grouped into a stand alone group and a portable group. A TV, a monitor, a settop box and the like can be included in the stand alone group. And, a PMP, a mobile phone, a navigation system and the like can be included in the portable group.

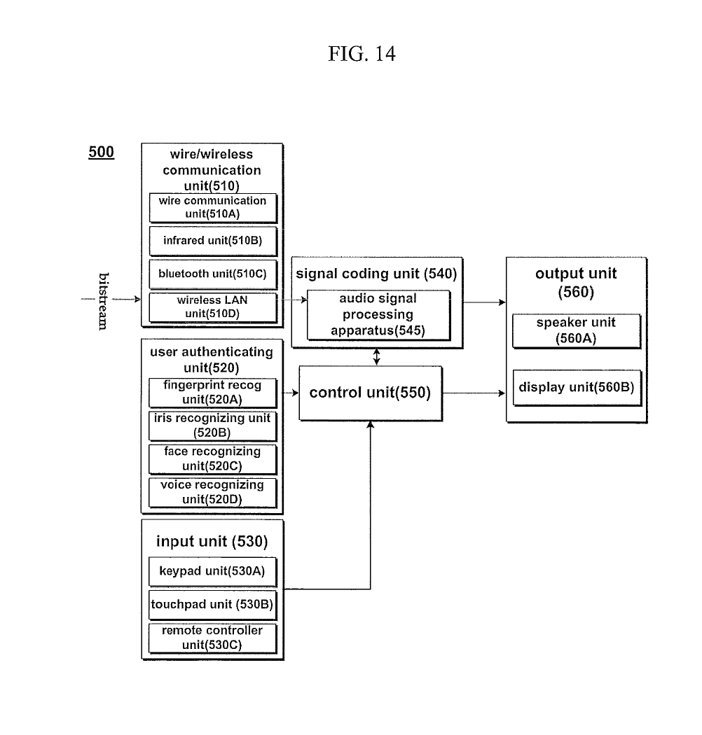

FIG. 14 shows relations between products, in which an audio signal processing apparatus according to an embodiment of the present invention is implemented.

Referring to FIG. 14, a wire/wireless communication unit 510 receives a bitstream via wire/wireless communication system. In particular, the wire/wireless communication unit 510 can include at least one of a wire communication unit 510A, an infrared unit 510B, a Bluetooth unit 510C and a wireless LAN unit 510D.

A user authenticating unit 520 receives an input of user information and then performs user authentication. The user authenticating unit 520 can include at least one of a fingerprint recognizing unit 520A, an iris recognizing unit 520B, a face recognizing unit 520C and a voice recognizing unit 520D. The fingerprint recognizing unit 520A, the iris recognizing unit 520B, the face recognizing unit 520C and the speech recognizing unit 520D receive fingerprint information, iris information, face contour information and voice information and then convert them into user informations, respectively. Whether each of the user informations matches pre-registered user data is determined to perform the user authentication.

An input unit 530 is an input device enabling a user to input various kinds of commands and can include at least one of a keypad unit 530A, a touchpad unit 530B and a remote controller unit 530C, by which the present invention is non-limited.

A signal coding unit 540 performs encoding or decoding on an audio signal and/or a video signal, which is received via the wire/wireless communication unit 510, and then outputs an audio signal in time domain. The signal coding unit 540 includes an audio signal processing apparatus 545. As mentioned in the foregoing description, the audio signal processing apparatus 545 corresponds to the above-described embodiment (i.e., the encoding side 100 and/or the decoding side 200) of the present invention. Thus, the audio signal processing apparatus 545 and the signal coding unit including the same can be implemented by at least one or more processors.

A control unit 550 receives input signals from input devices and controls all processes of the signal decoding unit 540 and an output unit 560. In particular, the output unit 560 is an element configured to output an output signal generated by the signal decoding unit 540 and the like and can include a speaker unit 560A and a display unit 560B. If the output signal is an audio signal, it is outputted to a speaker. If the output signal is a video signal, it is outputted via a display.

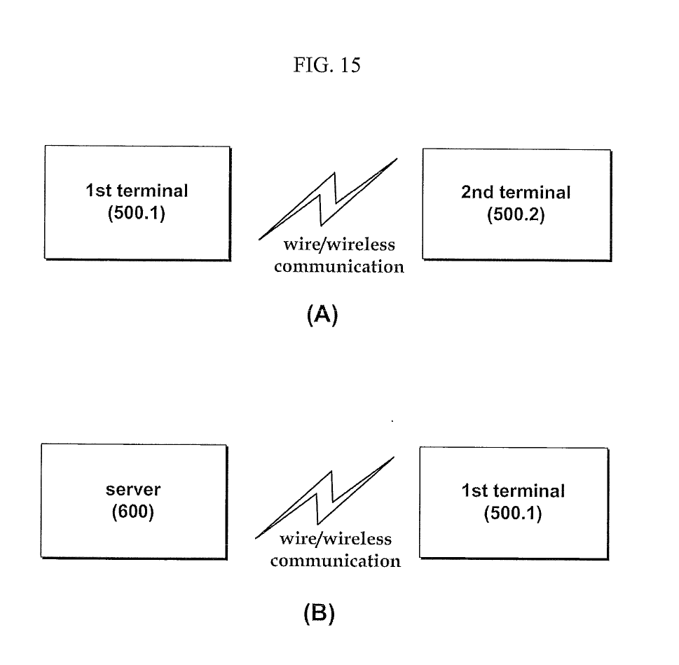

FIG. 15 is a diagram for relations of products provided with an audio signal processing apparatus according to an embodiment of the present invention. FIG. 15 shows the relation between a terminal and server corresponding to the products shown in FIG. 14.

Referring to (A) of FIG. 15, it can be observed that a first terminal 500.1 and a second terminal 500.2 can exchange data or bitstreams bi-directionally with each other via the wire/wireless communication units.

Referring to FIG. (B) of FIG. 15, it can be observed that a server 600 and a first terminal 500.1 can perform wire/wireless communication with each other.

An audio signal processing method according to the present invention can be implemented into a computer-executable program and can be stored in a computer-readable recording medium. And, multimedia data having a data structure of the present invention can be stored in the computer-readable recording medium. The computer-readable media include all kinds of recording devices in which data readable by a computer system are stored. The computer-readable media include ROM, RAM, CD-ROM, magnetic tapes, floppy discs, optical data storage devices, and the like for example and also include carrier-wave type implementations (e.g., transmission via Internet). And, a bitstream generated by the above mentioned encoding method can be stored in the computer-readable recording medium or can be transmitted via wire/wireless communication network.

Accordingly, the present invention provides the following effects and/or advantages.

First of all, since the present invention is based on the relation between a specific coding scheme and information related to the specific coding scheme, it is able to omit the information related to the specific coding scheme for a frame or subframe to which a different coding scheme is applied. Therefore, the present invention is able to reduce the number of bits of a bitstream considerably.

Secondly, since information corresponding to a specific scheme is extracted from a bitstream according to a presence or non-presence of relation to a scheme applied to a current fame or subframe only, the present invention is able to obtain necessary information efficiently by barely increasing complexity for a parsing process.

Thirdly, the present invention transmits a difference value from a corresponding value of a previous frame for information (e.g., mode information related to a specific coding scheme) having a value similar for each frame instead of transmitting the value intact, thereby further reducing the number of bits.

Accordingly, the present invention is applicable to processing and outputting an audio signal.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

What is claimed is:

1. A method for processing an audio signal, comprising:
extracting, by an audio processing apparatus, scheme type information indicating either time excitation scheme or frequency excitation scheme for each of a plurality of subframes included in current frame;
when the time excitation scheme is applied to at least one subframe among the plurality of subframes according to the scheme type information, extracting mode information representing bit allocation of codebook index for the current frame; and,
when the mode information is extracted, decoding the at least one subframe using the mode information according to the time excitation scheme.

2. The method of claim 1, further comprising:
when the frequency excitation scheme is applied to all the plurality subframes according to the scheme type information, decoding the all the plurality subframes according to the frequency excitation scheme.

3. The method of claim 1, wherein decoding the at least one subframe comprises:
extracting the codebook index using the mode information; and,
decoding the at least one subframe using the codebook index according to the time excitation scheme.

4. The method of claim 1, further comprising:
when the time excitation scheme is applied to at least one subframe among the plurality of subframes according to the scheme type information, extracting flag information indicating whether the mode information corresponds to either difference value or absolute value; and,
when the flag information indicates that the mode information corresponds to the difference value, obtaining a mode value of the current frame using the mode information of the current frame and a mode value of a previous frame.

5. An apparatus for processing an audio signal, comprising:
a scheme type information obtaining part extracting scheme type information indicating either time excitation scheme or frequency excitation scheme for each of a plurality of subframes included in current frame;
a mode information obtaining part, when the time excitation scheme is applied to at least one subframe among the plurality of subframes according to the scheme type information, extracting mode information representing bit allocation of codebook index for the current frame; and,
a time excitation scheme unit, when the mode information is extracted, decoding the at least one subframe using the mode information according to the time excitation scheme.

6. The apparatus of claim 5, further comprising:
a frequency excitation scheme unit, when the frequency excitation scheme is applied to all the plurality subframes according to the scheme type information, decoding the all the plurality subframes according to the frequency excitation scheme.

7. The apparatus of claim 5, further comprising:
a codebook information obtaining part extracting the codebook index using the mode information; and,
wherein the time excitation scheme unit decodes the at least one subframe using the codebook index according to the time excitation scheme.

8. The apparatus of claim 5, wherein the mode information obtaining part, when the time excitation scheme is applied to at least one subframe among the plurality of subframes according to the scheme type information, extracts flag information indicating whether the mode information corresponds to either difference value or absolute value,
when the flag information indicates that the mode information corresponds to difference value, obtains a mode value of the current frame using the mode information of the current frame and a mode value of a previous frame.

9. A method for processing an audio signal, comprising:
obtaining scheme type information indicating either time excitation scheme or frequency excitation scheme for each of a plurality of subframes included in current frame;
obtaining mode information representing bit allocation of codebook index for the current frame; and,
when the time excitation scheme is applied to at least one subframe among the plurality of subframes according to the scheme type information, encoding the mode information by inserting the mode information into a bitstream.

10. An apparatus for processing an audio signal, comprising:
a signal classifier obtaining scheme type information indicating either time excitation scheme or frequency excitation scheme for each of a plurality of subframes included in current frame;
a time excitation scheme unit obtaining mode information representing bit allocation of codebook index for the current frame; and,
a mode information encoding unit, when the time excitation scheme is applied to at least one subframe among the plurality of subframes according to the scheme type information, encoding the mode information by inserting the mode information into a bitstream.

11. A computer-readable medium having instructions stored thereon, which, when executed by a processor, causes the processor to perform operations, comprising:
extracting, by an audio processing apparatus, scheme type information indicating either time excitation scheme or frequency excitation scheme for each of a plurality of subframes included in current frame;
when the time excitation scheme is applied to at least one subframe among the plurality of subframes according to the scheme type information, extracting mode information representing bit allocation of codebook index for the current frame;
when the mode information is extracted, decoding the at least one subframe using the mode information according to the time excitation scheme.
